(19) United States
(12) Patent Application Publication
(10) Pub. No.: US 2005/0246285 A1
(43) Pub. Date: Nov. 3, 2005

(54) SOFTWARE LICENSING USING MOBILE AGENTS

(75) Inventors: Nikhil M. Chakravarthy, Arlington, TX (US); Farhad A. Kamangar, Arlington, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: BOARD OF REGENTS, THE UNIVERSITY OF TEXAS SYSTEM, Austin, TX (US)

(21) Appl. No.: 10/907,459

(22) Filed: Apr. 1, 2005

Related U.S. Application Data
(60) Provisional application No. 60/558,453, filed on Apr. 1, 2004.

(51) Int. Cl. G06F 17/60; H04K 1/00; H04L 9/00

(52) U.S. Cl. 705/59

(57) ABSTRACT

A system and method of licensing software using specialized set of code segments comprising: selecting a software to install on a workstation; inputting relevant information to access the software from a remote server, wherein relevant information may include information regarding the workstation or the user; randomly choosing a generator and verifier algorithm pair in a remote server; generating a key from the relevant information and the digital fingerprint of the workstation; storing the key and the verifier algorithm on a server; downloading the software onto a workstation; installing the software onto a workstation; requesting the server for the key and the verifier algorithm during or after installation; creating a specialized set of code segments; embedding the specialized set of code segments with the key and the verifier algorithm; sending the specialized set of code segments to the workstation; and executing the verifier algorithm to check the user's current inputs, wherein if the user's current inputs are verified, the specialized set of code segments installs patch software enabling full installation of the software.

### BACKGROUND

The present invention relates to the general field of electronic software and digital content and more particularly to software licensing. Concern over the security of sensitive information and commercial applications have generated various cryptographic algorithms and protocols protecting data from the clutches of unauthorized hands. Traditionally, however, sales and licensing mechanisms that controlled access to applications focused primarily on securing revenue. Companies today are increasingly also concerned with “who” is using their software.

Traditionally, software had been widely distributed electronically through shareware or trial versions. These versions did not succeed in generating revenue because of applications that “crack” the software and allow unrestricted use. “Crack” applications or software patches disable usage control mechanisms in the products. Thus, the user no longer has to purchase the software to keep using it after the trial period has ended. See “nTitles System” http://www.protexis.com. Although copyright laws make it illegal to create and distribute such “cracking” applications, such applications are widely available. Drew Clark, “Future of intellectual property: How copyright became controversial,” Proceedings of the 12th Annual Conference on Computers, Freedom and Privacy, Apr. 2002.

Electronic distribution of software and digital content over the Internet has increased dramatically. With this explosive growth, those who own and distribute software over the Internet face complicated security concerns over these transactions. Currently, licensing schemes are generally enforced through software itself. One such scheme, for example, is to store the license key inside the software. A simple graphical user interface, a GUI software module, would compare the user-entered key with the stored key. If a match is detected, the software awards the user unrestricted access to all its features. This method is easily defeated by those skilled in the art by simply converting a “jump on equal” instruction to a “jump on not equal” instruction.

Another scheme known in the art is to store a key validating function rather than the key itself in the software to make the software run-able, when the user provides a valid “key”. This scheme, though difficult to “crack”, will not prevent multiple installations. Other schemes known in the art include code obfuscation and watermarking. See Ditterman, J., “Combining digital waterworks and collusion secure fingerprints for customer copy monitoring”, Secure Images and Image Authentication (Ref. No. 2000/039), IEEE Seminar 2000, pp. 6/1-6/6 and Collberg, C. S., Thomborson, C., “Watermarking, tamper-proofing, and obfuscation—tools for software protection”, IEEE Transactions on Software Engineering, Vol: 28, Issue: 8, Aug. 2002 pp. 735-46.

Licensing schemes known in the art all disclose the “key” to the user. The user, therefore, may choose to make multiple copies of the software and reuse the key indiscriminately. What is needed, therefore, is a method of preventing software piracy by blocking a user's access to the licensing key.

### SUMMARY OF THE INVENTION

The present invention overcomes the aforementioned limitations in an effective and efficient manner, and provides for expanded use of mobile agents to prevent a user's access to software licensing keys. By utilizing an infrastructure that requires a dedicated server to store digital fingerprints and fragmented software, the licensing scheme of the present invention blocks the user's access to software keys and thus prevents software piracy.

### BRIEF DESCRIPTION OF THE DRAWINGS

The above and further advantages of the present invention may be better understood by referring to the following description in conjunction with the accompanying drawings, in which:

FIG. 1 is an illustration of a prior art licensing scheme;

FIG. 2 is an illustration of software licensing with mobile agents of the present invention; and

FIG. 3 is illustration of the sequence of steps of software licensing with mobile agents of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

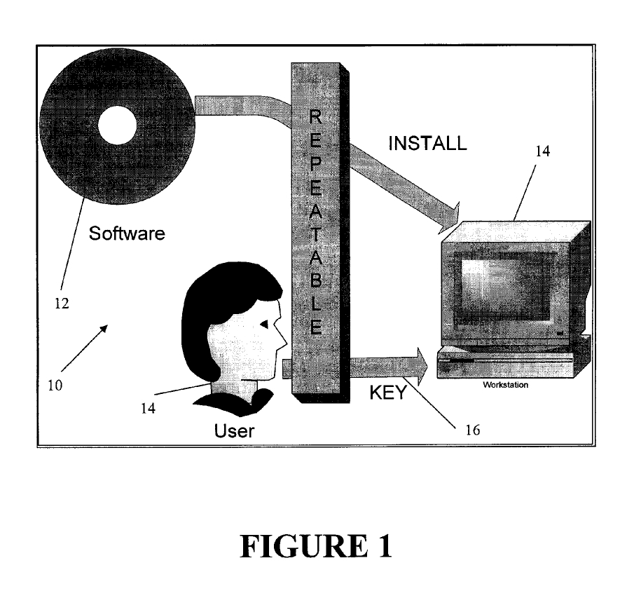

Current licensing schemes 10 make use of a single algorithm which makes software application 12 run-able, when the user 14 provides a valid “key” 16, as generally depicted in FIG. 1. There are several algorithms known in the art. In one such algorithm, a “key” 16, stored in the application 12, is compared to the key entered by the user 14. In another algorithm, a verifier algorithm stored in the application 12 verifies the “key” 16 that a generator algorithm provides to the user 14. Applications 12 known in the art disclose the key 16 to the user 14, as illustrated in FIG. 1. The process is repeatable and thus there are no mechanisms currently available that prevent the user 14 from making multiple copies of the software 12 and/or reuse the key 16 at other workstations 18.

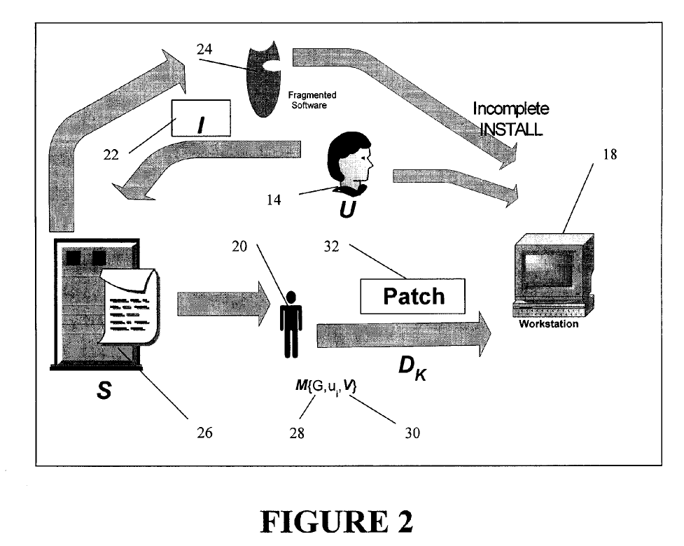

The present invention, however, does not allow a user 14 to access licensing keys 16. Referring now to FIG. 2, by providing expanded use of a specialized set of code segments or mobile agents 20, the present invention utilizes an infrastructure that requires a dedicated server to store “digital fingerprints” 22 and fragmented software 24. The digital fingerprints 22 verify whether a user 14 is authorized to have access to the software 12. Without this authorization, the user 14 only has access to fragmented software 24 and not the fully functional or complete software 12. For example, in accordance with one aspect of the present invention, when a user 14 purchases and downloads software 12 from the Internet, the user 14 will be required to provide one or more of the following predetermined relevant information, for example, parameters such as: network cards, MAC addresses, IP addresses, machine name, physical memory size, hard drive specification, processor type, video card specification, etc. In other words, the present invention can authenticate information with respect to origin and data integrity thus sufficiently generating unique information for a given user 14 and user's machine 18. This information combined with a user's information, such as a personal identification number, make up the information packet or “digital fingerprint” 22.

Generally, the process begins with a user 14 purchasing software 12. According to a specific aspect of the present invention, the software 12 should be segregated into two or more pieces. One piece is downloaded from the Internet and/or distributed by some physical media, such as a CD-ROM. The second piece, stored on the server 26, is encrypted when a download has been initiated. The encryption may be incorporated by a number of authentication algorithms known in the art, such as electronic certification, digital signatures and non-repudiation. See Bruce Schneier, “Applied Cryptography: Protocols, Algorithms, and Source Code in C”, John Wiley & Sons, Inc., 2^{nd} ed.

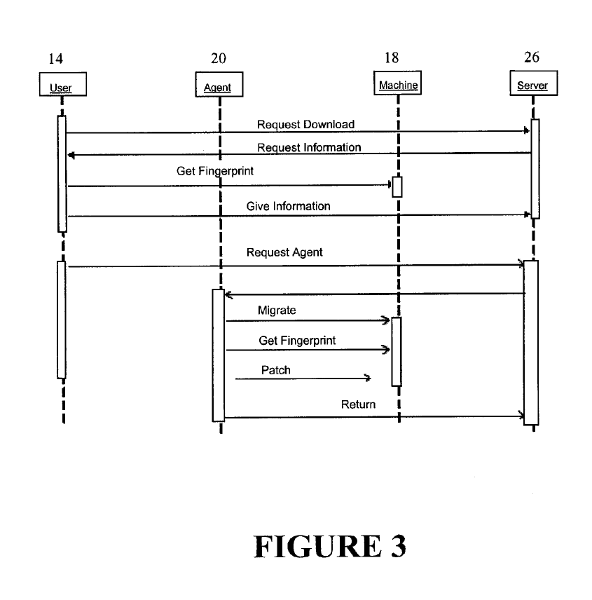

The second piece may be downloaded and installed fully only after the verification process is complete. The verification process begins with the server 26 randomly choosing a generator 28 and verifier algorithm 30, as depicted in FIGS. 2 and 3. The generator 28 stores the information packet 22 provided by the user 14 and generates a customized key 16. The server 26 stores the key 16 and a corresponding verifier algorithm 30 until called upon. When the user 14 downloads the software 12 and begins to installs it, both the verifier algorithm 30 and a key 16 are required for completing the download and for fully installing the software 12.

During the installation process, or alternatively, after the installation process, the user 14 requests the server 26 for the verifier algorithm 30 and the key 16. The server 26 creates a mobile agent 20. The mobile agent 20 embeds the verifier algorithm 30 and key 16. See Sunstead, Todd, “An introduction to agents”, JAVA World, Jun. 1998. Once the agent 20 is received by the user's machine 18, it executes and prompts the user 14 for the elements of the information packet 22 provided previously. Upon verification, the mobile agent 20 uses the unique information packet 22 as the symmetric “key” to decrypt the fragmented software 24 on the user's machine 18. In other words, the mobile agent 20 installs the requisite patch 32 necessary to enable the software 12 to fully function. The mobile agent 20 optionally returns to the server 26 and may not be called upon again by the user 14. Thus, the present invention has completed a licensing scheme wherein the software maintains adequate licensing protection and security by preventing a user 14 from accessing keys.

1. A method of licensing software comprising:
selecting a software to install on a workstation;
retrieving a portion of software from some means of software distribution;
inputting relevant information to access the software from a remote server,
wherein relevant information may include information regarding the workstation or the user;
randomly choosing a generator and verifier algorithm pair in a remote server;
generating a key from the relevant information and the digital fingerprint of the workstation;
storing the key and the verifier algorithm on a server;
downloading the encrypted software onto a workstation;
installing the software onto a workstation;
requesting the server for the key and the verifier algorithm during or after installation;
creating a specialized set of code segments;
embedding the specialized set of code segments with the key and the verifier algorithm;
sending the specialized set of code segments to the workstation; and
executing the verifier algorithm to check the user's current inputs, wherein if the user's current inputs are verified, the specialized set of code segments installs patch software enabling full installation of the software.

2. The method of claim 1, wherein the step of executing the verifier algorithm further comprises returning the specialized set of code segments to the server when verification fails or is complete.

3. A system for downloading software and completing licensing agreements comprising:
a user workstation adapted to receive at least a portion of the computer program and further adapted to receive user input;
a world wide web connection;
a user accessible server, wherein the server maintains at least a portion of the computer program in encrypted form and is adapted to the world wide web connection;
a user inaccessible key to decrypt the computer program;
entity information, wherein the entity information describes the user workstation;
data information, wherein the data information describes user identification;
a digital fingerprint comprising the entity information and the data information in encrypted form;
a generator algorithm communicably connected to the server and adapted to receive the digital fingerprint and output the key;
a verifier algorithm communicably connected to the server and adapted to verify the digital fingerprint;
a patch adapted to decrypt the software after the digital fingerprint is authenticated by the verifier algorithm; and
a specialized set of code segments adapted to receive the verifier algorithm and the key from the server and deliver the verifier algorithm and the key to the computer workstation using the world wide web, wherein the specialized set of code segments is further adapted to deliver the patch to the software if the specialized set of code segments verifies the user input.

4. The system of claim 3, wherein the computer program initially adapted by the user workstation is from the Internet or some other physical media for software distribution.

5. The system of claim 3, wherein the specialized set of code segments can be used only once to receive the verifier algorithm and the key from the server.
